(19) United States
(12) Patent Application Publication
(10) Pub. No.: US 2006/0209792 A1
(43) Pub. Date: Sep. 21, 2006

(54) VOIP TO WIRELESS GATEWAY

(75) Inventor: Alfred R. Nurnberger, Portland, OR (US)

Correspondence Address: TIMOTHY E SIEGEL, 1868 KNAPPS ALLEY, SUITE 206, WEST LINN, OR, 97068, US

(73) Assignee: LOGITEL CORPORATION, Vancouver, WA (US)

(21) Appl. No.: 11/160,225

(22) Filed: Jun. 14, 2005

Related U.S. Application Data
(60) Provisional application No. 60/654,328, filed on Feb. 17, 2005.

(51) Int. Cl. H04L 12/66

(52) U.S. Cl. 370/352; 370/401

(57) ABSTRACT

A VoIP to wireless gateway, comprising an internet protocol interface, adapted to be connected to a standard data line. Additionally, a data processing unit is connected to the internet protocol interface, includes an audio port assembly and is adapted to sort streams of internet protocol packets from the internet protocol interface and to arrange them into a set of audio signals which are transmitted by way of the audio port assembly, and to do the reverse operation for signals arriving from the audio port assembly. Also, a set of wireless transceivers are communicatively connected to the data processing unit. Also included is a power supply that powers both the data processing assembly and the set of wireless transceivers.

### RELATED APPLICATION

This application claims priority from provisional application Ser. No. 60/654,328 filed Feb. 17, 2005.

### BACKGROUND OF THE INVENTION

Voice-over-internet protocol (VoIP) telephony has become increasingly popular because it is generally less expensive for the party placing a telephone call than alternative systems. Accordingly, several vendors have begun offering VoIP “gateways,” that is electronic devices for assembling packets of data from the Internet to create a voice signal, and for receiving a voice signal and creating a sequence of data packets that are sent over the Internet to a destination.

Unfortunately, it has proven very difficult to create a VoIP gateway that may be easily configured and put into service by someone other than a professional trained in an arcane computer language. Many of the configuration choices do not occur in other environments, so most users are not familiar with the terms that can be used to describe these choices. This problem has slowed the adoption of VoIP technology.

In addition, generally available VoIP gateways typically have no way to direct calls to different channels of a T1 line depending on the characteristics of the telephone number entered. This presents a difficulty to the user who wishes to handle different T1 line channels, or groups of channels differently from others.

Also, there appears to be currently no gateway that translates VoIP data packets directly into wireless telephone encoded signals. Wireless telephony, however, is increasingly popular. Moreover, in many situations the least cost strategy for terminating a long distance telephone call to a wireless telephone is to terminate by way of a wireless unit that is registered with the same carrier as the wireless telephone being called.

Currently, many cell phones have a feature known as “push-to-talk over cellular” or “PoC,” in which a first cell phone may activate a second cell phone and establish a link between the two so that subsequently merely pushing a button on either cell phone opens up the channel with the other, with no need for “answering” the other cell phone. It appears, however, that there is currently no way of achieving the same end with a land line

### SUMMARY OF THE INVENTION

In a first separate aspect, the present invention is a wireless transceiver card, comprising a multiplicity of wireless transceivers and a standard computer bus interface connected to the multiplicity of wireless transceivers.

In a second separate aspect, the present invention is a VoIP to wireless gateway, comprising an IP interface, adapted to be connected to a standard data line. Additionally, a data processing unit is connected to the IP interface, includes an audio port assembly and is adapted to sort streams of IP packets from the IP interface and to arrange them into a set of audio signals which are transmitted by way of the audio port assembly, and to do the reverse operation for signals arriving from the audio port assembly. Also, a set of wireless transceivers are communicatively connected to the data processing unit. Also included is a power supply that powers both the data processing assembly and the set of wireless transceivers.

In a third separate aspect, the present invention is a VoIP to wireless gateway, comprising an IP interface, adapted to be connected to a standard data line. Additionally, a data processing unit is connected to the IP interface, includes an audio port assembly and is adapted to sort streams of IP packets from the IP interface and to arrange them into a set of audio signals which are transmitted by way of the audio port assembly, and to do the reverse operation for signals arriving from the audio port assembly. Also, a set of wireless transceivers are communicatively connected to the data processing unit. Also, a single housing encompasses and protects both the set of wireless transceivers and the data processing unit.

In a fourth separate aspect, the present invention is a VoIP to wireless gateway, comprising an IP interface, adapted to be connected to a standard data line. Additionally, a data processing unit is connected to the IP interface, includes an audio port assembly and is adapted to sort streams of IP packets from the IP interface and to arrange them into a set of audio signals which are transmitted by way of the audio port assembly, and to do the reverse operation for signals arriving from the audio port assembly. Also, a set of wireless transceivers are communicatively connected to the data processing unit. Also, the data processing unit includes a PC motherboard.

In a fifth separate aspect, the present invention is a VoIP to wireless gateway, comprising an IP interface, adapted to be connected to a standard data line. Additionally, a data processing unit is connected to the IP interface. This unit includes an audio port assembly and is adapted to sort streams of IP packets from the IP interface and to arrange them into a set of audio signals which are transmitted by way of the audio port assembly. The data processing unit also does the reverse operation for signals arriving from the audio port assembly. Also, a set of wireless transceivers are communicatively connected to the data processing unit. Additionally, the data processing unit includes a control kernel, which controls both the data processing unit and the set of wireless transceivers.

In a sixth separate aspect, the present invention is a VoIP to wireless gateway, comprising an IP interface, adapted to be connected to a standard data line. Additionally, a data processing unit is connected to the IP interface, includes an audio port assembly and is adapted to sort streams of IP packets from the IP interface and to arrange them into a set of audio signals which are transmitted by way of the audio port assembly, and to do the reverse operation for signals arriving from the audio port assembly. Also, a set of wireless transceivers are communicatively connected to the data processing unit. Further, the data processing unit and the set of wireless transceivers are connected by way of a standard computer bus.

In a seventh separate aspect, the present invention is a VoIP to wireless gateway, comprising an IP interface, adapted to be connected to a standard data line. Additionally, a data processing unit is connected to the IP interface, includes an audio port assembly and is adapted to sort streams of IP packets from the IP interface and to arrange them into a set of audio signals which are transmitted by way of the audio port assembly, and to do the reverse operation for signals arriving from the audio port assembly. Also, a set of wireless transceivers are communicatively connected to the data processing unit. Additionally, the set of wireless transceivers and the data processing unit can be configured by way of a connection formed at a single interface and over a single time duration to the gateway.

In an eighth separate aspect, the present invention is a VoIP to wireless gateway, comprising an IP interface, adapted to be connected to a standard data line. Additionally, a data processing unit is connected to the IP interface, includes an audio port assembly and is adapted to sort streams of IP packets from the IP interface and to arrange them into a set of audio signals which are transmitted by way of the audio port assembly, and to do the reverse operation for signals arriving from the audio port assembly. Also, a set of wireless transceivers are communicatively connected to the data processing unit. Further, the IP interface is a wireless IP interface, adapted to send and receive data over a frequency assigned to wireless telephony.

In a ninth separate aspect, the present invention is a VoIP to wireless gateway, comprising an IP interface, adapted to be connected to a standard data line. Additionally, a data processing unit is connected to the IP interface, includes an audio port assembly and is adapted to sort streams of IP packets from the IP interface and to arrange them into a set of audio signals which are transmitted by way of the audio port assembly, and to do the reverse operation for signals arriving from the audio port assembly. Also, a set of wireless transceivers are communicatively connected to the data processing unit. Further, the data processing unit is configured to match a called telephone number on a telephone call arriving over the IP interface to a substantially least cost option for terminating the arriving telephone call.

In a tenth separate aspect, the present invention is a VoIP to wireless gateway, comprising an IP interface, adapted to be connected to a standard data line. Additionally, a data processing unit is connected to the IP interface, includes an audio port assembly and is adapted to sort streams of IP packets from the IP interface and to arrange them into a set of audio signals which are transmitted by way of the audio port assembly, and to do the reverse operation for signals arriving from the audio port assembly. Also, a set of wireless transceivers are communicatively connected to the data processing unit. Further for at least some of the wireless transceivers, each has a socket to receive a chip bearing credit toward a prepaid amount of wireless time.

In an eleventh separate aspect, the present invention is a VoIP to wireless gateway, comprising an IP interface, adapted to be connected to a standard data line. Additionally, a data processing unit is connected to the IP interface, includes an audio port assembly and is adapted to sort streams of IP packets from the IP interface and to arrange them into a set of audio signals which are transmitted by way of the audio port assembly, and to do the reverse operation for signals arriving from the audio port assembly. Also, a set of wireless transceivers are communicatively connected to the data processing unit. Further, the data processing unit is configured to receive a signal from a telephone line of said multi-line telephone cable, this signal cueing the data processing unit to establish a push to talk over cellular connection with a specified wireless telephone.

The foregoing and other objectives, features and advantages of the invention will be more readily understood upon consideration of the following detailed description of the preferred embodiment(s), taken in conjunction with the accompanying drawings.

### BRIEF DESCRIPTION OF THE DRAWINGS

FIG. 1 is a functional block diagram of the operations performed by a VoIP to wireless gateway according to the present invention.

FIG. 2 is a block diagram showing the components of the VoIP to wireless gateway of FIG. 1.

### DETAILED DESCRIPTION OF THE PREFERRED EMBODIMENT(S)

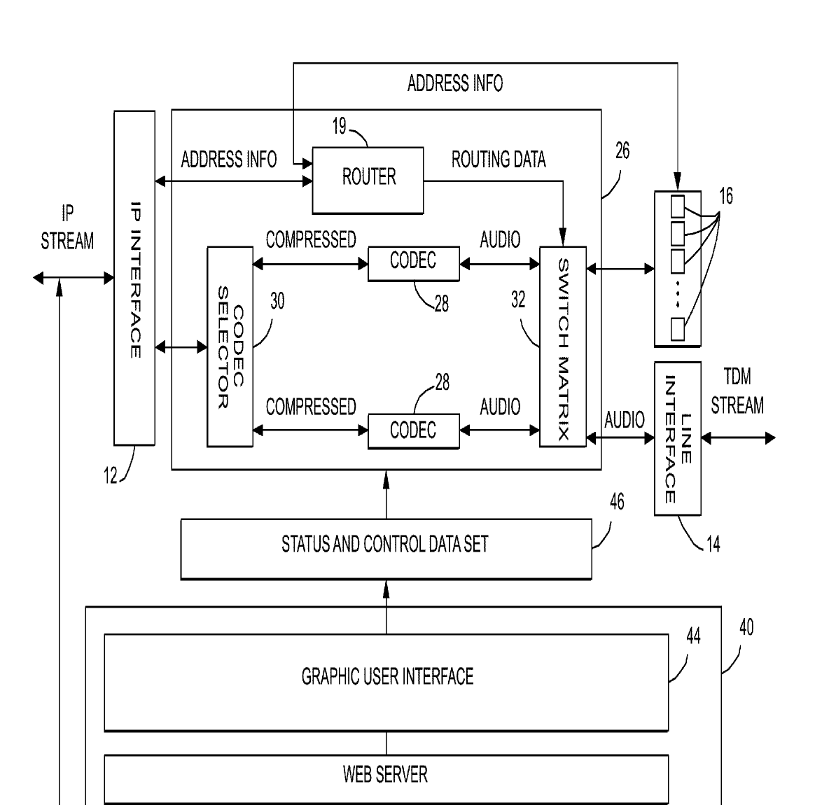

Referring to FIG. 1, which illustrates the workings of a VoIP gateway in broad functional blocks, a VoIP gateway 10 according to the present invention, includes an internet protocol (IP) interface 12, which would typically connected to a DSL line, or a cable modem. In one preferred embodiment IP interface 12 is a wireless data line port forming a broadband wireless connection, for example an EVDO line. Also a standard telephony line interface 14 which is typically connected to T1 lines, if the gateway 10 is being used in the United States. If the gateway 10 is placed in use in Europe or another place using the European standard, E1 lines would be used. For Japan and other places using the Japanese standard, a J1 line would be used. In an alternative preferred embodiment, gateway 10 includes additional functional blocks that permit it to serve as a private automated branch exchange (PABX). In addition to telephone line interface 14, a bank of wireless transceivers 16 is available for terminating telephone calls incoming from port 12.

A signal routing and processing block 26, includes a set of codecs 28 and a codec selector 30, which compress the voice data and decompress the internet data, according to which way the data is directed. This is all done in accordance with already well known principals, so it is not described here. A switch matrix 32, connects each call incoming from interface 12 to a T1 line channel of interface 14 or a wireless transceiver 16.

Turning now to wireless transceivers 16, each of which is essentially the electronics of a cell phone, as the mouth piece, speaker and key pad of a cell phone are all unnecessary. One international standard for cell phone systems, Global System for Mobile Communications (“GSM”) is used by over a billion cell phone subscribers in more than 200 countries. This standard specifies the use of a subscriber identity module (“SIM chip”), which is removable and bears the telephone number that one must call to reach the cell phone. This scheme permits a cell phone user to dispose of an old cell phone and transfer his telephone number to a new cell phone without having to contact and arrange the matter with his service provider. Other standards also specify the use of a SIM chip.

Also, in Europe and other areas it is very easy to tell which telephone numbers are associated with which wireless service provider because each wireless service provider is assigned a particular area code. In many regions preferential pricing is provided for telephone calls placed between wireless accounts that both belong to the same service provider. Accordingly, there is an advantage to terminating any call arriving over IP interface 12 by way of a wireless unit that self identifies as being part of the network of the service provider to which the called telephone number belongs.

Accordingly, at least some wireless transceivers 16 are constructed to accept a SIM chip. In this manner the user of gateway 10 may change his assignment of cell modules to wireless service providers. In addition, some SIM chips provide an indication of an amount of prepaid wireless time, potentially simplifying wireless provider billing. The use of wireless transceivers that accept SIM chips may be useful, for example, if one wireless service provider gains popularity over another. Not every wireless service provider, however, supports cell phones that use SIM chips. Accordingly, some cell modules 16 would typically be supplied as registered cell phone equivalents.

A nonvolatile memory assembly 40, a webserver 42 and a graphical user interface memory 44, which includes the information necessary to display a graphical user interface for guiding a new user through a set-up procedure and for facilitating later adjustments to the operation of gateway 10. This process is used to create a status and control data set 46, which is used to control data processing unit 60.

Many of the screen displays of the graphical user interface (GUI) are presented in U.S. patent application Ser. No. 11/038975, filed Jan. 19, 2005, which is hereby incorporated by reference as if fully set forth herein. In general, the GUI permits a user to configure the system so that telephone calls arriving over digital port 12 are routed in the least cost manner. For example, a telephone call terminating at a cell phone supported by a particular service provider would be recognized (either by the area code of the called telephone number or the prefix) and would be terminated as a telephone call over a wireless transceiver 16 also associated with that service provider.

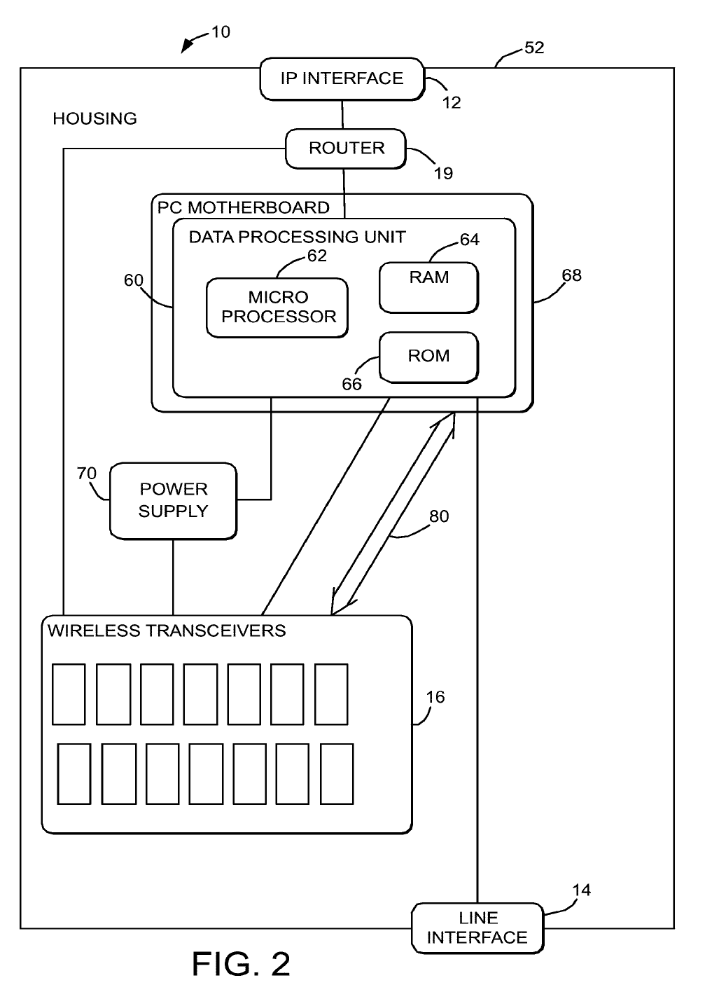

Turning now to the structural block diagram gateway 10 shown in FIG. 2, a single housing 52 covers and protects both the wireless transceivers 16 and a data processing unit 60, which performs the functions of the codec selector 30, the codecs 28 and the switch matrix 32. By placing the data processing unit 60 and the wireless transceivers 16 in the same physical unit, which a single housing 52, greater manufacturing efficiency is achieved then in the prior art, in which these units were separate.

Unit 60 is communicatively connected to the bank of wireless transceivers 16 by way of a standard computer bus 80, such as a peripheral component interface (PCI) bus, a FireWire bus (also known as an i.Link or IEEE 1394 bus), or a universal serial bus (USB). In a preferred embodiment, data processing unit 60 is resident on a PC motherboard 68, which is the standard term for the type of motherboard found in a IBM style PC. The use of standard buses and components greatly facilitates assembly and use of the preferred embodiment.

Unit 60 also causes the display of the graphic user interface 44, which prompts a user to enter configuration data during set-up and receives and stores the status and control data set 46. In the prior art, a unit having a bank of wireless transceivers had to be configured separately from the VoIP gateway with which it cooperated. The GUI of the preferred embodiment, however, guides a user through a configuration routine for both the data processing unit 60 and the bank of wireless transceivers 16 in a single communicative and temporal connection. This results in a great user convenience.

Additionally, the data processing unit 60 performs the higher level control functions for itself and for the wireless transceiver bank 16. For example, the task of selecting between functionally equivalent wireless transceivers 16 for terminating a telephone call arriving on port 12 is performed by data processing unit 60. In the prior art this task was performed by a mechanism on a physically separate cell module bank unit. Also, the translation of called telephone number arriving on interface 12, into a form understandable by transceivers 16 is performed by unit 60. The ability to have unit 60 control both the wireless transceivers 16 and the VoIP gateway functions represents an efficiency in the gateway 10 over previous configurations in which the gateway 10 and the bank of wireless transceivers 16 were separate. Data processing unit includes a microprocessor 62, random access memory 64, for storing voice and internet protocol (IP) data, and read only memory 64, in which the control functions and the graphical user interface information are stored.

A power supply 70, supplies DC power at the correct voltages to both the wireless transceivers 16 and the data processing unit 60. It is an efficiency of the present embodiment that a single power supply 70 supplies both the data processing unit and the wireless transceivers 16.

In an additional feature, a predetermined signal entering from a particular telephone line of the standard telephony line interface 14 can be used to open a push to talk over cellular, by way of a wireless transceiver 16, with a designated wireless telephone. It is anticipated that gateway 10 may be connected to a private automated branch exchange (PABX) and that this feature will permit a land line user in a facility using the PABX to establish a PoC connection with a wireless telephone, which could in some circumstances greatly ease a communicative task.

The terms and expressions that have been employed in the foregoing specification are used as terms of description and not of limitation. There is no intention, in the use of such terms and expressions, of excluding equivalents of the features shown and described or portions thereof, it being recognized that the scope of the invention is defined and limited only by the claims which follow.

1. A VoIP to wireless gateway, comprising:
(a) an internet protocol interface;
(b) a data processing unit, connected to said internet protocol interface and including an audio port assembly, and adapted to sort streams of internet protocol packets from said internet protocol interface and to arrange them into a set of audio signals which are transmitted by way of said audio port assembly, and to do the reverse operation for signals arriving from said audio port assembly;
(c) a set of wireless transceivers, communicatively connected to said data processing unit; and
(d) wherein said internet protocol interface is a wireless internet protocol interface, adapted to send and receive data over a frequency assigned to wireless telephony.

2. The VoIP to wireless gateway of claim 1, wherein said wireless internet protocol interface is adapted to connect to a broadband wireless data line.

3. The VoIP to wireless gateway of claim 1, wherein said wireless internet protocol interface is adapted to connect to an EVDO line.

4. A VoIP to wireless gateway, comprising:
(a) an internet protocol interface;
(b) a data processing unit, connected to said internet protocol interface and including an audio port assembly, and adapted to sort streams of internet protocol packets from said internet protocol interface and to arrange them into a set of audio signals which are transmitted by way of said audio port assembly, and to do the reverse operation for signals arriving from said audio port assembly;
(c) a set of wireless transceivers, communicatively connected to said data processing unit; and
(d) wherein said data processing unit is configured to match a called telephone number on a telephone call arriving over said internet protocol interface to a least cost option for terminating said arriving telephone call.

5. The VoIP to wireless gateway of claim 4, further comprising at least one telephone line interface, adapted to connect to a multi-line telephone cable and communicatively connected to said data processing unit and wherein said least cost option for terminating said arriving telephone call may be a line of said multi-line telephone cable.

6. The VoIP to wireless gateway of claim 4, wherein an incoming call from a specific cellular service provider is routed to a wireless transceiver contracted to said specific cellular service provider.

7. A VoIP to wireless gateway, comprising:
(a) an internet protocol interface;
(b) a data processing unit, connected to said internet protocol interface and including an audio port assembly, and adapted to sort streams of internet protocol packets from said internet protocol interface and to arrange them into a set of audio signals which are transmitted by way of said audio port assembly, and to do the reverse operation for signals arriving from said audio port assembly;
(c) a set of wireless transceivers, communicatively connected to said data processing unit; and
(d) wherein for at least some of said wireless transceivers, each has a socket to receive a wireless chip bearing credit toward a prepaid amount of wireless time.

8. The VoIP to Wireless gateway of claim 7 wherein said data processing unit apportions calls to said wireless chips so that all of said wireless chips have their prepaid amount of wireless time exhausted substantially contemporaneously.

9. A VoIP to wireless gateway, comprising:
(a) an internet protocol interface;
(b) a data processing unit, connected to said internet protocol interface and including an audio port assembly, and adapted to sort streams of internet protocol packets from said internet protocol interface and to arrange them into a set of audio signals which are transmitted by way of said audio port assembly, and to do the reverse operation for signals arriving from said audio port assembly;
(c) a set of wireless transceivers, communicatively connected to said data processing unit;
(d) at least one telephone line interface, adapted to connect to a multi-line telephone cable and communicatively connected to said data processing unit; and
(e) wherein said data processing unit is configured to receive a signal from a telephone line of said multi-line telephone cable, said signal cueing said data processing unit to establish a push to talk over cellular connection with a specified wireless telephone.
